(19) United States
(12) Patent Application Publication
(10) Pub. No.: US 2023/0290082 A1
(43) Pub. Date: Sep. 14, 2023

(54) REPRESENTATION OF USERS BASED ON CURRENT USER APPEARANCE

(71) Applicant: APPLE INC., Cupertino, CA (US)

(72) Inventors: Brian Amberg, Zurich (CH); Nicolas V. Scapel, London (GB); Jason D. Rickwald, Santa Cruz, CA (US); Dorian D. Dargan, Oakland, CA (US); Gary I. Butcher, Los Gatos, CA (US); Giancarlo Yerkes, San Carlos, CA (US); William D. Lindmeier, San Francisco, CA (US); John S. McCarten, Boulder, CO (US)

(21) Appl. No.: 18/125,277

(22) Filed: Mar. 23, 2023

Related U.S. Application Data
(63) Continuation of application No. PCT/US2021/049989, filed on Sep. 13, 2021.
(60) Provisional application No. 63/083,359, filed on Sep. 25, 2020.

(51) Int. Cl. G06T 19/00; G06T 17/00; G06T 5/00; G06T 7/246; G06T 13/40

(52) U.S. Cl. CPC G06T 19/006; G06T 17/00; G06T 5/001; G06T 7/246; G06T 13/40; G06T 2207/30201

(57) ABSTRACT

Various implementations disclosed herein include devices, systems, and methods that generates and displays a portion of a representation of a face of a user. For example, an example process may include obtaining a first set of data corresponding to features of a face of a user in a plurality of configurations, while a user is using an electronic device, obtaining a second set of data corresponding to one or more partial views of the face from one or more image sensors, generating a representation of the face of the user based on the first set of data and the second set of data, wherein portions of the representation correspond to different confidence values, and displaying the portions of the representation based on the corresponding confidence values.

### CROSS-REFERENCE TO RELATED APPLICATIONS

This patent application is a continuation of International Application No. PCT/US2021/049989 filed on Sep. 13, 2021, which claims the benefit of U.S. Provisional Application No. 63/083,359 filed on Sep. 25, 2020, both entitled “REPRESENTATION OF USERS BASED ON CURRENT USER APPEARANCE,” each of which is incorporated herein by this reference in its entirety.

### TECHNICAL FIELD

The present disclosure generally relates to electronic devices, and in particular, to systems, methods, and devices for representing users in computer-generated content.

### BACKGROUND

Existing techniques may not accurately or accurately present current (e.g., real-time) representations of the appearances of users of electronic devices. For example, a device may provide an avatar representation of a user based on images of the user's face that were obtained minutes, hours, days, or even years before. Such a representation may not accurately represent the user's current (e.g., real-time) appearance, for example, not showing the user's avatar as smiling when the user is smiling or not showing the user's current beard. Thus, it may be desirable to provide a means of efficiently providing more accurate, realistic, and/or current representations of users.

### SUMMARY

Various implementations disclosed herein include devices, systems, and methods that present a representation of a face of a user using live partial images of the user's face and previously-obtained face data (e.g., enrollment data). The representation is realistic in the sense that portions of the representation are displayed based on assessing confidence that the respective portion accurately corresponds to the live appearance of the user's face. Portions of the representation having low confidence may be blurred, modified, and/or hidden.

In general, one innovative aspect of the subject matter described in this specification can be embodied in methods that include the actions of, at a processor, obtaining a first set of data corresponding to features of a face of a user, while a user is using an electronic device, obtaining a second set of data corresponding to one or more partial views of the face from one or more image sensors, generating a representation of the face of the user based on the first set of data and the second set of data, wherein portions of the representation correspond to different confidence values, and displaying the portions of the representation based on the corresponding confidence values.

These and other embodiments can each optionally include one or more of the following features.

In some aspects, the first set of data includes unobstructed image data of the face of the user. In some aspects, the second set of data includes partial images of the face of the user.

In some aspects, the electronic device includes a first sensor and a second sensor, where the second set of data is obtained from at least one partial image of the face of the user from the first sensor from a first viewpoint and from at least one partial image of the face of the user from the second sensor from a second viewpoint that is different than the first viewpoint.

In some aspects, the confidence values correspond to texture confidence value, wherein displaying the portions of the representation based on the corresponding confidence values includes determining that the texture confidence value exceeds a threshold.

In some aspects, generating the representation of the face of the user includes tracking the features of the face of the user, generating a model based on the tracked features, and updating the model by projecting live image data onto the model. In some aspects, generating the representation of the face of the user further includes enhancing the model based on the first set of data.

In some aspects, the representation is a three-dimensional (3D) avatar.

In some aspects, the portions of the representation are displayed based on assessing confidence that the respective portion accurately corresponds to a live appearance of the face of the user. In some aspects, the portions of the representation are displayed differently based on a confidence level of the corresponding confidence values.

In some aspects, the second set of data includes depth data and light intensity image data obtained during a scanning process.

In some aspects, the electronic device is a head-mounted device (HMD).

In accordance with some implementations, a non-transitory computer readable storage medium has stored therein instructions that are computer-executable to perform or cause performance of any of the methods described herein. In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates a device displaying a visual experience and obtaining physiological data from a user according to some implementations.

FIG. 2 is a flowchart representation of a method for generating and displaying portions of a representation of a face of a user in accordance with some implementations.

FIGS. 3A and 3B illustrate examples of generating and displaying portions of a representation of a face of a user in accordance with some implementations.

FIG. 4 illustrates a system flow diagram that can generate and display portions of a representation of a face of a user in accordance with some implementations.

FIG. 5 is a block diagram illustrating device components of an exemplary device according to some implementations.

FIG. 6 is a block diagram of an example head-mounted device (HMD) in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects or variants do not include all of the specific details described herein. Moreover, well-known systems, methods, components, devices and circuits have not been described in exhaustive detail so as not to obscure more pertinent aspects of the example implementations described herein.

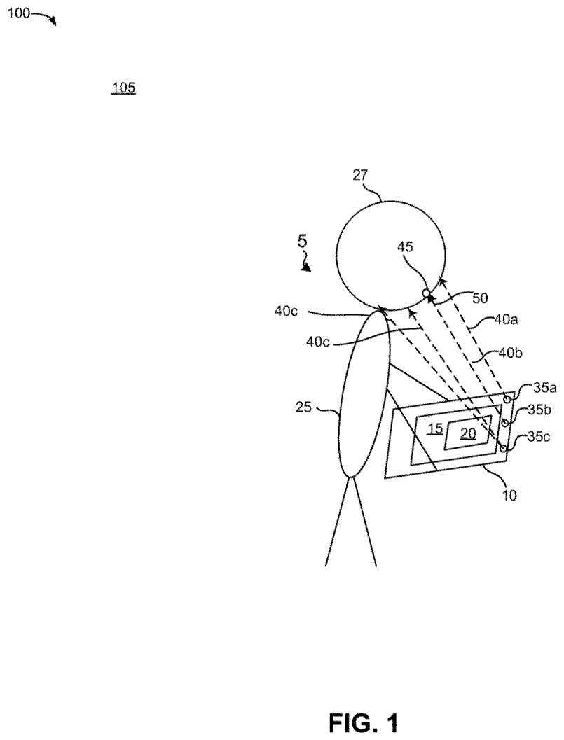

FIG. 1 illustrates an example environment 100 of a real-world environment 105 (e.g., a room) including a device 10 with a display 15. In some implementations, the device 10 displays content 20 to a user 25. For example, content 20 may be a button, a user interface icon, a text box, a graphic, an avatar of the user or another user, etc. In some implementations, the content 20 can occupy the entire display area of display 15.

The device 10 obtains image data, motion data, and/or physiological data (e.g., pupillary data, facial feature data, etc.) from the user 25 via a plurality of sensors (e.g., sensors 35a, 35b, and 35c). For example, the device 10 obtains eye gaze characteristic data 40b via sensor 35b, upper facial feature characteristic data 40a via sensor 35a, and lower facial feature characteristic data 40c via sensor 35c.

While this example and other examples discussed herein illustrate a single device 10 in a real-world environment 105, the techniques disclosed herein are applicable to multiple devices as well as to other real-world environments. For example, the functions of device 10 may be performed by multiple devices, with the sensors 35a, 35b, and 35c on each respective device, or divided among them in any combination.

In some implementations, the plurality of sensors (e.g., sensors 35a, 35b, and 35c) may include any number of sensors that acquire data relevant to the appearance of the user 25. For example, when wearing an HMD, one sensor (e.g., a camera inside the HMD) may acquire the pupillary data for eye tracking, and one sensor on a separate device (e.g., one camera, such as a wide range view) may be able to capture all of the facial feature data of the user. Alternatively, if the device 10 is an HMD, a separate device may not be necessary. For example, if the device 10 is an HMD, in one implementation, sensor 35b may be located inside the HMD to capture the pupillary data (e.g., eye gaze characteristic data 40b), and additional sensors (e.g., sensor 35a and 35c) may be located on the HMD but on the outside surface of the HMD facing towards the user's head/face to capture the facial feature data (e.g., upper facial feature characteristic data 40a via sensor 35a, and lower facial feature characteristic data 40c via sensor 35c).

In some implementations, as illustrated in FIG. 1, the device 10 is a handheld electronic device (e.g., a smartphone or a tablet). In some implementations the device 10 is a laptop computer or a desktop computer. In some implementations, the device 10 has a touchpad and, in some implementations, the device 10 has a touch-sensitive display (also known as a “touch screen” or “touch screen display”). In some implementations, the device 10 is a wearable device such as an HMD.

In some implementations, the device 10 includes an eye tracking system for detecting eye position and eye movements via eye gaze characteristic data 40b. For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user 25. Moreover, the illumination source of the device 10 may emit NIR light to illuminate the eyes of the user 25 and the NIR camera may capture images of the eyes of the user 25. In some implementations, images captured by the eye tracking system may be analyzed to detect position and movements of the eyes of the user 25, or to detect other information about the eyes such as color, shape, state (e.g., wide open, squinting, etc.), pupil dilation, or pupil diameter. Moreover, the point of gaze estimated from the eye tracking images may enable gaze-based interaction with content shown on the near-eye display of the device 10.

In some implementations, the device 10 has a graphical user interface (GUI), one or more processors, memory and one or more modules, programs or sets of instructions stored in the memory for performing multiple functions. In some implementations, the user 25 interacts with the GUI through finger contacts and gestures on the touch-sensitive surface. In some implementations, the functions include image editing, drawing, presenting, word processing, website creating, disk authoring, spreadsheet making, game playing, telephoning, video conferencing, e-mailing, instant messaging, workout support, digital photographing, digital videoing, web browsing, digital music playing, and/or digital video playing. Executable instructions for performing these functions may be included in a computer readable storage medium or other computer program product configured for execution by one or more processors.

In some implementations, the device 10 employs various physiological sensor, detection, or measurement systems. Detected physiological data may include, but is not limited to, electroencephalography (EEG), electrocardiography (ECG), electromyography (EMG), functional near infrared spectroscopy signal (fNIRS), blood pressure, skin conductance, or pupillary response. Moreover, the device 10 may simultaneously detect multiple forms of physiological data in order to benefit from synchronous acquisition of physiological data. Moreover, in some implementations, the physiological data represents involuntary data, e.g., responses that are not under conscious control. For example, a pupillary response may represent an involuntary movement.

In some implementations, one or both eyes 45 of the user 25, including one or both pupils 50 of the user 25 present physiological data in the form of a pupillary response (e.g., eye gaze characteristic data 40b). The pupillary response of the user 25 results in a varying of the size or diameter of the pupil 50, via the optic and oculomotor cranial nerve. For example, the pupillary response may include a constriction response (miosis), e.g., a narrowing of the pupil, or a dilation response (mydriasis), e.g., a widening of the pupil. In some implementations, the device 10 may detect patterns of physiological data representing a time-varying pupil diameter.

The user data (e.g., upper facial feature characteristic data 40a, lower facial feature characteristic data 40c, and eye gaze characteristic data 40b) may vary in time and the device 10 may use the user data to generate and/or provide a representation of the user.

In some implementations, the user data (e.g., upper facial feature characteristic data 40a and lower facial feature characteristic data 40c) includes texture data of the facial features such as eyebrow movement, chin movement, nose movement, cheek movement, etc. For example, when a person (e.g., user 25) smiles, the upper and lower facial features (e.g., upper facial feature characteristic data 40a and lower facial feature characteristic data 40c) can include a plethora of muscle movements that may be replicated by a representation of the user (e.g., an avatar) based on the captured data from sensors 35.

According to some implementations, the device 10 may generate and present a computer-generated reality (CGR) environment to their respective users. A CGR environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands).

A person may sense and/or interact with a CGR object using any one of their senses, including sight, sound, touch, taste, and smell. For example, a person may sense and/or interact with audio objects that create three-dimensional (3D) or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects. In some implementations, the image data is pixel-registered with the images of the physical environment 105 (e.g., RGB, depth, and the like) that is utilized with the imaging process techniques within the CGR environment described herein.

Examples of CGR include virtual reality and mixed reality. A virtual reality (VR) environment refers to a simulated environment that is designed to be based entirely on computer-generated sensory inputs for one or more senses. A VR environment includes virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end.

In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground.

Examples of mixed realities include augmented reality and augmented virtuality. An augmented reality (AR) environment refers to a simulated environment in which one or more virtual objects are superimposed over a physical environment 105, or a representation thereof. For example, an electronic system for presenting an AR environment may have a transparent or translucent display through which a person may directly view the physical environment 105. The system may be configured to present virtual objects on the transparent or translucent display, so that a person, using the system, perceives the virtual objects superimposed over the physical environment 105. Alternatively, a system may have an opaque display and one or more imaging sensors that capture images or video of the physical environment 105, which are representations of the physical environment 105. The system composites the images or video with virtual objects, and presents the composition on the opaque display. A person, using the system, indirectly views the physical environment 105 by way of the images or video of the physical environment 105, and perceives the virtual objects superimposed over the physical environment 105. As used herein, a video of the physical environment shown on an opaque display is called “pass-through video,” meaning a system uses one or more image sensor(s) to capture images of the physical environment 105, and uses those images in presenting the AR environment on the opaque display. Further alternatively, a system may have a projection system that projects virtual objects into the physical environment 105, for example, as a hologram or on a physical surface, so that a person, using the system, perceives the virtual objects superimposed over the physical environment 105.

An augmented reality environment also refers to a simulated environment in which a representation of a physical environment 105 is transformed by computer-generated sensory information. For example, in providing pass-through video, a system may transform one or more sensor images to impose a select perspective (e.g., viewpoint) different than the perspective captured by the imaging sensors. As another example, a representation of a physical environment 105 may be transformed by graphically modifying (e.g., enlarging) portions thereof, such that the modified portion may be representative but not photorealistic versions of the originally captured images. As a further example, a representation of a physical environment 105 may be transformed by graphically eliminating or obfuscating portions thereof.

An augmented virtuality (AV) environment refers to a simulated environment in which a virtual or computer-generated environment incorporates one or more sensory inputs from the physical environment 105. The sensory inputs may be representations of one or more characteristics of the physical environment 105. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment 105.

There are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one implementation, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

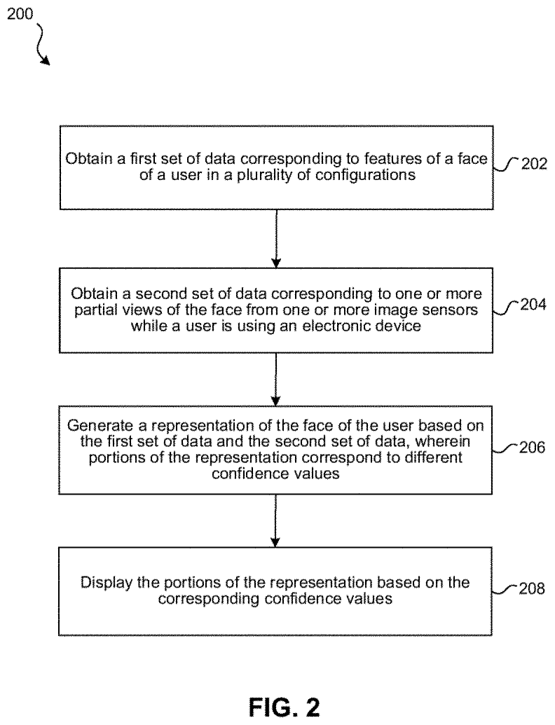

FIG. 2 is a flowchart illustrating an exemplary method 200. In some implementations, a device (e.g., device 10 of FIG. 1) performs the techniques of method 200 to generate and display portions of a representation of a face of a user (e.g., an avatar) based on the user's facial features and gaze characteristic(s). In some implementations, the techniques of method 200 are performed on a mobile device, desktop, laptop, HMD, or server device. In some implementations, the method 200 is performed on processing logic, including hardware, firmware, software, or a combination thereof. In some implementations, the method 200 is performed on a processor executing code stored in a non-transitory computer-readable medium (e.g., a memory).

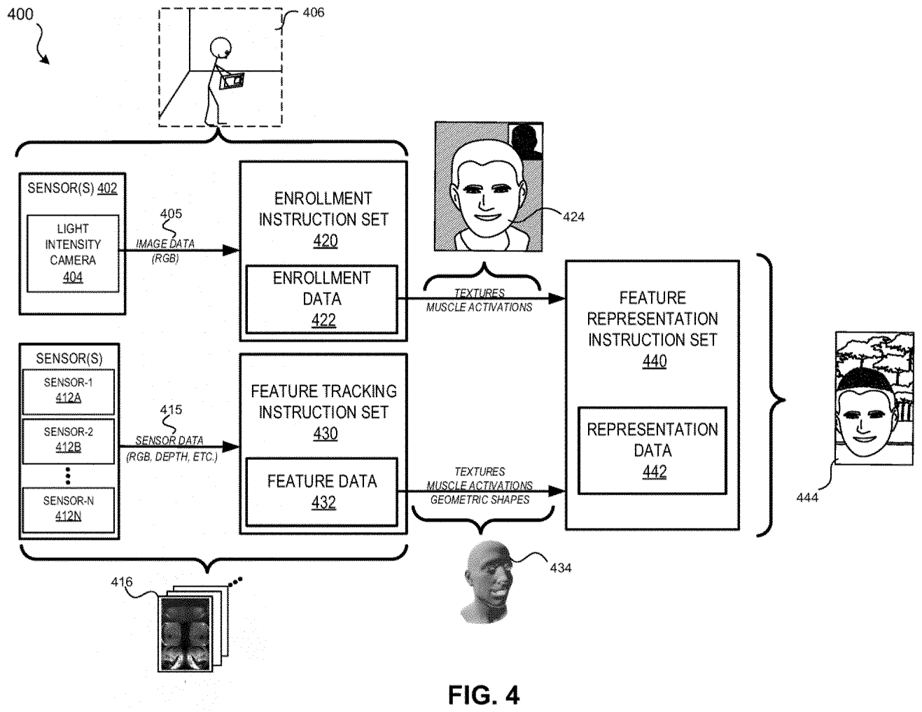

At block 202, the method 200 obtains a first set of data (e.g., enrollment data) corresponding to features (e.g., texture, muscle activation, shape, depth, etc.) of a face of a user in a plurality of configurations from a device (e.g., device 10 of FIG. 1). In some implementations, the first set of data includes unobstructed image data of the face of the user. For example, images of the face may be captured while the user is smiling, brows raised, cheeks puffed out, etc. In some implementations, enrollment data may be obtained by a user taking the device (e.g., an HMD) off and capturing images without the device occluding the face or using another device (e.g., a mobile device) without the device (e.g., HMD) occluding the face. In some implementations, the enrollment data (e.g., the first set of data) is acquired from light intensity images (e.g., RGB image(s)). The enrollment data may include textures, muscle activations, etc., for most, if not all, of the user's face. In some implementations, the enrollment data may be captured while the user is provided different instructions to acquire different poses of the user's face. For example, the user may be instructed by a user interface guide to “raise your eyebrows,” “smile,” “frown,” etc., in order to provide the system with a range of facial features for an enrollment process. The enrollment process is further described herein with reference to FIG. 4.

At block 204, the method 200 obtains a second set of data corresponding to one or more partial views of the face from one or more image sensors while a user is using (e.g., wearing) an electronic device (e.g., HMD). In some implementations, the second set of data includes partial images of the face of the user and thus may not represent all of the features of the face that are represented in the enrollment data. For example, the second set of images may include an image of some of the foreface/brow eyes (e.g., facial feature characteristic data 40a) from an upward-facing sensor (e.g., sensor 35a of FIG. 1). Additionally, or alternatively, the second set of images may include an image of some of the eyes (e.g., eye gaze characteristic data 40b) from an inward-facing sensor (e.g., sensor 35a of FIG. 1). Additionally, or alternatively, the second set of images may include an image of some of the cheeks, mouth and chin (e.g., facial feature characteristic data 40c) from a downward facing sensor (e.g., sensor 35c of FIG. 1).

In some implementations, the second set of data and/or the first set of data includes depth data (e.g., infrared, time-of-flight, etc.) and light intensity image data obtained during a scanning process.

In some implementations, the electronic device includes a first sensor (e.g., sensor 35a of FIG. 1) and a second sensor (e.g., sensor 35c of FIG. 1), where the second set of data is obtained from at least one partial image of the face of the user from the first sensor from a first viewpoint (e.g., upper facial characteristic data 40a) and from at least one partial image of the face of the user from the second sensor from a second viewpoint (e.g., lower facial characteristic data 40c) that is different than the first viewpoint.

At block 206, the method 200 generates a representation of the face of the user based on the first set of data and the second set of data, wherein portions of the representation correspond to different confidence values. In some implementations, generating a representation of the face of the user based on the first set of data (e.g., enrollment data) and the second set of data (e.g., facial feature and eye gaze characteristic data) may involve using face tracking to generate a model. For example, the model may include a 3D model, a muscle model, multiple dimensions of face, and the like. In some implementations, the device data (e.g., HMD data) and live camera data may be projected onto the model. For example, the model may be enhanced using the enrollment data during playback of the live camera data. For example, inpainting may be used to enhance the model using enrollment data during a communication session.

In some implementations, the representation of the face may include sufficient data to enable a stereo view of the face (e.g., left/right eye views) to the face to be perceived with depth. In one implementation, a representation of a face includes a 3D model of the face and views of the representation from a left eye position and a right eye position are generated to provide a stereo view of the face.

In some implementations, certain parts of the face that may be of importance to conveying a realistic or accurate appearance, such as the eyes and mouth, may be generated differently than other parts of the face. For example, parts of the face that may be of importance to conveying a realistic or accurate appearance may be based on current camera data while other parts of the face may be based on previously-obtained (e.g., enrollment) face data.

In some implementations, a representation of a face is generated with texture, color, and/or geometry for various face portions and confidence value identifying an estimate of how confident the generation technique is that such textures, colors, and/or geometries accurately correspond to the real texture, color, and/or geometry of those face portions. Displaying the portions of the representation may be based on the corresponding confidence values. For example, whether a generated texture is used or not for a given portion of the representation may be based on determining whether the texture confidence value exceeds a threshold. Confidence values may represent uncertainty of one or more of texture, color, and/or geometry. Additionally, confidence thresholds may be selected to account for various factors. For example, a low confidence threshold for a nose portion of a face may result in a blurry or otherwise undesirable nose appearance, which may be disturbing to viewers more so than a blurry ear or other portion of the face. To address such a potential, the method 200 may involve selecting a relatively higher confidence threshold for a nose portion of the face that avoids a blurry or otherwise undesirable nose appearance.

In some implementations, generating the representation of the face of the user includes tracking the features of the face of the user, generating a model (e.g., a 3D model, muscle model, multiple dimensions of face, etc.) based on the tracked features, and updating the model by projecting live image data onto the model.

In some implementations, the generated representation is a 3D avatar. For example, the representation is a 3D model that represents the user (e.g., user 25 of FIG. 1).

At block 208, the method 200 displays the portions of the representation based on the corresponding confidence values. The portions of the representation may include those that are determined to be only accurate/realistic portions of the avatar. For example, the portions of the representation are displayed based on assessing confidence that the respective portion (e.g., facial features such as the nose, chin, mouth, eye's, eyebrows, etc.) accurately corresponds to the live appearance of the user's face.

In some implementations, the method may be repeated for each frame captured during each instant/frame of a live communication session or other experience. For example, for each iteration, while the user is using the device (e.g., wearing the HMD), the method 200 may involve continuously obtaining the second set of data (e.g., eye gaze characteristic data and facial feature data), and for each frame, updating the displayed portions of the representation based on updated confidence values. For example, for each new frame of facial feature data, the system can determine whether a higher quality representation of the user is created and update the display of the 3D avatar based on the new data.

In some implementations, the portions of the representation are displayed based on assessing confidence that the respective portion accurately corresponds to a live appearance of the face of the user. For example, correlation confidence level may be determined to be greater than or equal to a confidence threshold (e.g., a greater than 60% confidence level that the nose is being generated accurately in the representation).

In some implementations, the portions of the representation are displayed differently based on a confidence level of the corresponding confidence values. For example, for a higher level of confidence (e.g., greater than 60% confidence level) the portion of the representation (e.g., nose) may be shown, but for a lower level of confidence (e.g., less than 40% confidence level) the portion of the representation (e.g., forehead) may be blurred and/or distorted. Thus, several different levels of confidence may provide different tiers of how each portion is shown. For example, the level of distortion or blurring out the portion of the representation may be based on the confidence level for that portion. The higher the level of confidence, the blur/distortion effect is reduced until a threshold level of confidence is reached and then the representation may be shown without any blur/distortion effect (e.g., greater than 80%).

In some implementations, an estimator or statistical learning method is used to better understand or make predictions about the physiological data (e.g., facial feature and gaze characteristic data). For example, statistics for gaze and facial feature characteristic data may be estimated by sampling a dataset with replacement data (e.g., a bootstrap method).

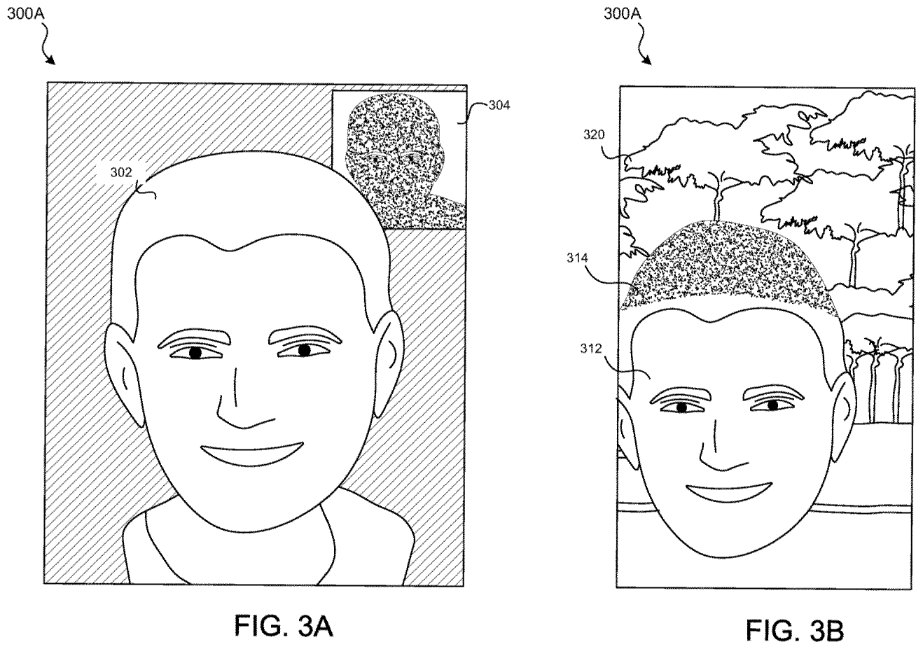

FIGS. 3A-3B illustrate examples of generating and displaying portions of a representation of a face of a user in accordance with some implementations. In particular, FIG. 3A illustrates an example illustration 300A of a user during an enrollment process. For example, the enrollment personification 302 is generated as the system obtains image data (e.g., RGB images) of the user's face while the user is providing different facial expressions. For example, the user may be told to “raise your eyebrows,” “smile,” “frown,” etc., in order to provide the system with a range of facial features for an enrollment process. The enrollment personification preview 304 is shown to the user while the user is providing the enrollment images to get a visualization of the status of the enrollment process. In this example, illustration 300A displays the enrollment personification 302 and the enrollment personification preview 304 overlaid within a CGR environment. Alternatively, the avatar 312 could be overlaid within a real-world physical environment (e.g., a mixed reality environment).

FIG. 3B illustrates an example illustration 300B of a user during an avatar display process. For example, the avatar 312 is generated based on acquired enrollment data and updated as the system obtains and analyzes and the real-time image data (e.g., the second set of data of FIG. 2 that may include the eye gaze characteristic data and facial feature data). In some implementations, the portions of the avatar 312 that are displayed correspond to confidence values of the user's face while the user is providing different facial expressions. For example, if there is a low confidence for a particular portion of the avatar, then the system may blur, modify, or hide that particular portion. As shown in illustration 300B, the avatar is blurred at portion 314, because the system has determined that an area on the head of the user, based on the obtained real-time data, is not sufficient to produce an accurate (e.g., a realistic representation) of the user at that particular time. In other words, the system will only display the portions of the avatar that have been determined to have satisfied a confidence threshold. In this example, illustration 300B displays the avatar 312 overlaid within a real-world physical environment (e.g., a mixed reality environment) 320. Alternatively, the avatar 312 could be overlaid within a CGR environment.

FIG. 4 is a system flow diagram of an example environment 400 in which a system can generate and display portions of a representation of a face of a user based on confidence values according to some implementations. In some implementations, the system flow of the example environment 400 is performed on a device (e.g., device 10 of FIG. 1), such as a mobile device, desktop, laptop, or server device. The images of the example environment 400 can be displayed on a device (e.g., device 10 of FIG. 1) that has a screen for displaying images and/or a screen for viewing stereoscopic images such as a head-mounted device (HMD). In some implementations, the system flow of the example environment 400 is performed on processing logic, including hardware, firmware, software, or a combination thereof. In some implementations, the system flow of the example environment 400 is performed on a processor executing code stored in a non-transitory computer-readable medium (e.g., a memory).

In some implementations, the system flow of the example environment 400 includes an enrollment process and an avatar display process. Alternatively, the example environment 400 may only include the avatar display process, and obtain the enrollment data from another source (e.g., previously stored enrollment data). In other words, the enrollment process may have already taken place such that the user's enrollment data is already provided because an enrollment process has already completed.

The system flow of the enrollment process of the example environment 400 acquires image data (e.g., RGB data) from sensors of a physical environment (e.g., the physical environment 105 of FIG. 1), and generates enrollment data. The enrollment data may include textures, muscle activations, etc., for the most, if not all, of the user's face. In some implementations, the enrollment data may be captured while the user is provided different instructions to acquire different poses of the user's face. For example, the user may be told to “raise your eyebrows,” “smile,” “frown,” etc., in order to provide the system with a range of facial features for an enrollment process.

The system flow of the avatar display process of the example environment 400 acquires image data (e.g., RGB, depth, IR, etc.) from sensors of a physical environment (e.g., the physical environment 105 of FIG. 1), determines facial feature data, obtains and assesses the enrollment data, and generates and displays portions of a representation of a face (e.g., a 3D avatar) of a user based on confidence values. For example, a generating and displaying portions of a representation of a face of a user technique described herein can be implemented on real-time sensor data that are streamed to the end user (e.g., a 3D avatar overlaid onto images of a physical environment within a CGR environment). In an exemplary implementation, the avatar display process occurs during real-time display (e.g., an avatar is updated in real-time as the user is making facial gestures and changes to his or her facial features). Alternatively, the avatar display process may occur while analyzing streaming image data (e.g., generating a 3D avatar for person from a video).

In an example implementation, the environment 400 includes an image composition pipeline that acquires or obtains data (e.g., image data from image source(s) such as sensors 402 and 412A-412N) of the physical environment. Example environment 400 is an example of acquiring image sensor data 405 (e.g., light intensity data—RGB) for the enrollment process and acquiring image sensor data 415 (e.g., light intensity data, depth data, and position information) for the avatar display process for a plurality of image frames. For example, illustration 406 (e.g., example environment 100 of FIG. 1) represents a user acquiring image data as the user scans his or her face and facial features in a physical environment (e.g., the physical environment 105 of FIG. 1) during an enrollment process. Image(s) 416 represent a user acquiring image data as the user scans his or her face and facial features in real-time (e.g., while wearing an HMD). The image sensor(s) 412A, 412B, through 412N (hereinafter referred to sensor 412) may include a depth camera that acquires depth data, a light intensity camera (e.g., RGB camera) that acquires light intensity image data (e.g., a sequence of RGB image frames), and position sensors to acquire positioning information.

For the positioning information, some implementations include a visual inertial odometry (VIO) system to determine equivalent odometry information using sequential camera images (e.g., light intensity data) to estimate the distance traveled. Alternatively, some implementations of the present disclosure may include a SLAM system (e.g., position sensors). The SLAM system may include a multidimensional (e.g., 3D) laser scanning and range measuring system that is GPS-independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location. The SLAM system may further be a visual SLAM system that relies on light intensity image data to estimate the position and orientation of the camera and/or the device.

In an example implementation, the environment 400 includes an enrollment instruction set 420 that is configured with instructions executable by a processor to generate enrollment data from sensor data. For example, the enrollment instruction set 420 acquires image data 405 from sensors 402 such as light intensity image data (e.g., RGB images from light intensity camera 404), and generates enrollment data 422 (e.g., facial feature data such as textures, muscle activations, etc.) of the user. For example, the enrollment instruction set generates the enrollment personification 424 (e.g., illustration 300A of FIG. 3). In some implementations, the enrollment instruction set 420 provides instructions to the user in order to acquire image information to generate the enrollment personification 424 and determine whether additional image information is needed to generate an accurate enrollment personification to be used by the avatar display process. For example, the instructions are determined by the enrollment instruction set 420. Those instructions may be provided to the user via audio and/or visual cues. The cues may include the instructional phrases such as “raise your eyebrows,” “smile,” “frown,” etc. Additionally, or alternatively, visual icons (e.g., arrows) or images (e.g., person smiling, person frowning, etc.) may be provided. The audio and/or visual cues provide the enrollment instruction set 420 with one or more images that provide a range of facial features for the enrollment process.

In an example implementation, the environment 400 includes a feature tracking instruction set 430 that is configured with instructions executable by a processor to generate feature data 432 from sensor data. For example, the feature tracking instruction set 430 acquires sensor data 415 from sensors 412 such as light intensity image data (e.g., live camera feed such as RGB from light intensity camera), depth image data (e.g., depth image data from a depth from depth camera such as infrared or time-of-flight sensor), and other sources of physical environment information (e.g., camera positioning information such as position and orientation data, e.g., pose data, from position sensors) of a user in a physical environment (e.g., user 25 in the physical environment 105 of FIG. 1), and generates feature data 432 (e.g., muscle activations, geometric shapes, latent spaces for facial expressions, etc.) for face tracking. For example, the feature data 432 can include feature representation 434 (e.g., texture data, muscle activation data, and/or geometric shape data of the face based on sensor data 415). Face tracking for feature tracking instruction set 430 may include taking partial views acquired from the sensor data 415 and determining from a geometric model small sets of parameters (e.g., the muscles of the face). For example, the geometric model may include sets of data for the eyebrows, the eyes, the cheeks below the eyes, the mouth area, the chin area, etc. The face tracking of the tracking instruction set 430 provides geometry of the facial features of the user.

In an example implementation, the environment 400 includes a feature representation instruction set 440 that is configured with instructions executable by a processor to generate a representation of the face (e.g., a 3D avatar) of the user based on the first set of data (e.g., texture and muscle activation data, such as enrollment data) and the second set of data (e.g., feature data), wherein portions of the representation correspond to different confidence values. Additionally, the feature representation instruction set 440 is configured with instructions executable by a processor to display the portions of the representation based on the corresponding confidence values. For example, the feature representation instruction set 440 acquires texture data and muscle activation data from enrollment data 422 from the enrollment instruction set 420, acquires feature data 432 from the feature tracking instruction set 430, and generates representation data 442 (e.g., a real-time representation of a user, such as a 3D avatar). For example, the feature representation instruction set 440 can generate the representation 444 (e.g., avatar 312 of FIG. 3).

In some implementations, the feature representation instruction set 440 acquires texture data directly from sensor data (e.g., RGB, depth, etc.). For example, feature representation instruction set 440 may acquire image data 405 from sensor(s) 402 and/or acquire sensor data 415 from sensors 412 in order to obtain texture data to generate the representation 444 (e.g., avatar 312 of FIG. 3).

In some implementations, the confidence values correspond to texture confidence value, wherein displaying the portions of the representation based on the corresponding confidence values includes determining that the texture confidence value exceeds a threshold (e.g., a greater than 60% confidence level that the nose is being generated accurately). For example, the confidence values may represent uncertainty of texture/color or proxy geometry. Additionally, confidence values may be adjusted and/or filtered to account for other factors. For example, a blurry nose may be disturbing so the method 200 may involve forcing the nose to have higher confidence threshold.

In some implementations, confidence values for each portion of the representation may be determined based on a confidence level in the enrollment data, a confidence level in the feature tracking data, or a combination of each. For example, determining whether to blur/distort a portion of the representation 444 based on confidence may be based only on a confidence level of the enrollment data for that particular portion (e.g., the forehead). Alternatively, determining whether to blur/distort a portion of the representation 444 based on confidence may be based only on a confidence level of the feature tracking data (e.g., real time tracking information) for that particular portion. In an exemplary implementation, determining whether to blur/distort a portion of the representation 444 may be based on a confidence level of the enrollment data 422 and the feature data 432.

In some implementations, the feature representation instruction set 440 provides real-time in-painting. To process real-time in-painting, the feature representation instruction set 440 utilizes the enrollment data 422 to aid in filling in the representation (e.g., representation 444) when the device identifies (e.g., via geometric matching) a specific expression that matches the enrollment data. For example, a portion of the enrollment process may include enrolling a user's teeth when he or she smiled. Thus, when the device identifies that the user is smiling during the real-time images (e.g., sensor data 415), the feature representation instruction set 440 in-paints the user's teeth from his or her enrollment data.

In some implementations, the process for real-time in-painting of the feature representation instruction set 440 is provided by a machine learning model (e.g., a trained neural network) to identify patterns in the textures (or other features) in the enrollment data 422 and the feature data 432. Moreover, the machine learning model may be used to match the patterns with learned patterns corresponding to the user 25 such as smiling, frowning, talking, etc. For example, when a pattern of smiling is determined from the showing of the teeth (e.g. geometric matching as described herein), there may also be a determination of other portions of the face that also change for the user when he or she smiles (e.g., cheek movement, eyebrows, etc.). In some implementations, the techniques described herein may learn patterns specific to the particular user 25.

In some implementations, the feature representation instruction set 440 may be repeated for each frame captured during each instant/frame of a live communication session or other experience. For example, for each iteration, while the user is using the device (e.g., wearing the HMD), the example environment 400 may involve continuously obtaining the feature data 432 (e.g., eye gaze characteristic data and facial feature data), and for each frame, update the displayed portions of the representation 444 based on updated confidence values. For example, for each new frame of facial feature data, the system can determine whether a higher quality representation of the user is created and update the display of the 3D avatar based on the new data.

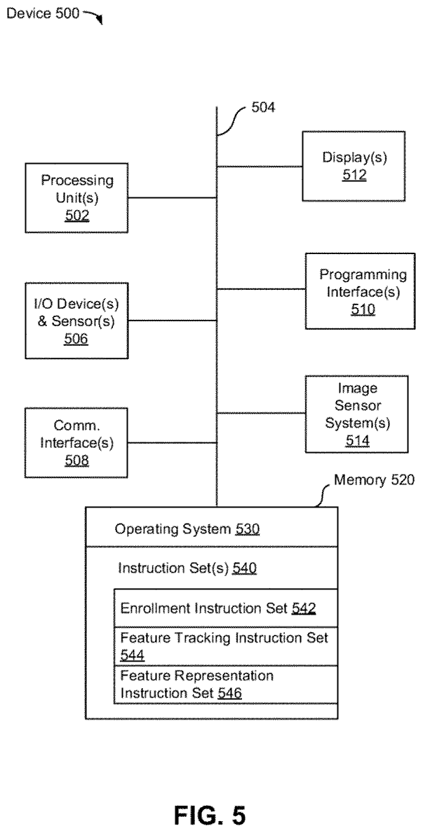

FIG. 5 is a block diagram of an example device 500. Device 500 illustrates an exemplary device configuration for device 10. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 10 includes one or more processing units 502 (e.g., microprocessors, ASICs, FPGAs, GPUs, CPUs, processing cores, and/or the like), one or more input/output (I/O) devices and sensors 506, one or more communication interfaces 508 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, 12C, and/or the like type interface), one or more programming (e.g., I/O) interfaces 510, one or more displays 512, one or more interior and/or exterior facing image sensor systems 514, a memory 520, and one or more communication buses 504 for interconnecting these and various other components.

In some implementations, the one or more communication buses 504 include circuitry that interconnects and controls communications between system components. In some implementations, the one or more I/O devices and sensors 506 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 512 are configured to present a view of a physical environment or a graphical environment to the user. In some implementations, the one or more displays 512 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 512 correspond to diffractive, reflective, polarized, holographic, etc. waveguide displays. In one example, the device 10 includes a single display. In another example, the device 10 includes a display for each eye of the user.

In some implementations, the one or more image sensor systems 514 are configured to obtain image data that corresponds to at least a portion of the physical environment 105. For example, the one or more image sensor systems 514 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 514 further include illumination sources that emit light, such as a flash. In various implementations, the one or more image sensor systems 514 further include an on-camera image signal processor (ISP) configured to execute a plurality of processing operations on the image data.

The memory 520 includes high-speed random-access memory, such as DRAM, SRAM, DDR RAM, or other random-access solid-state memory devices. In some implementations, the memory 520 includes non-volatile memory, such as one or more magnetic disk storage devices, optical disk storage devices, flash memory devices, or other non-volatile solid-state storage devices. The memory 520 optionally includes one or more storage devices remotely located from the one or more processing units 502. The memory 520 includes a non-transitory computer readable storage medium.

In some implementations, the memory 520 or the non-transitory computer readable storage medium of the memory 520 stores an optional operating system 530 and one or more instruction set(s) 540. The operating system 530 includes procedures for handling various basic system services and for performing hardware dependent tasks. In some implementations, the instruction set(s) 540 include executable software defined by binary information stored in the form of electrical charge. In some implementations, the instruction set(s) 540 are software that is executable by the one or more processing units 502 to carry out one or more of the techniques described herein.

The instruction set(s) 540 include a enrollment instruction set 542, a feature tracking instruction set 544, and a feature representation instruction set 546. The instruction set(s) 540 may be embodied a single software executable or multiple software executables.

In some implementations, the enrollment instruction set 542 is executable by the processing unit(s) 502 to generate enrollment data from image data. The enrollment instruction set 542 (e.g., enrollment instruction set 420 of FIG. 4) may be configured to provide instructions to the user in order to acquire image information to generate the enrollment personification (e.g. enrollment personification 424) and determine whether additional image information is needed to generate an accurate enrollment personification to be used by the avatar display process. To these ends, in various implementations, the instruction includes instructions and/or logic therefor, and heuristics and metadata therefor.

In some implementations, the feature tracking (e.g., eye gaze characteristics and facial features) instruction set 544 (e.g., feature tracking instruction set 430 of FIG. 4) is executable by the processing unit(s) 502 to track a user's facial features and eye gaze characteristics using one or more of the techniques discussed herein or as otherwise may be appropriate. To these ends, in various implementations, the instruction includes instructions and/or logic therefor, and heuristics and metadata therefor.

In some implementations, the feature representation instruction set 546 (e.g., feature representation instruction set 440 of FIG. 4) is executable by the processing unit(s) 502 to generate and display a representation of the face (e.g., a 3D avatar) of the user based on the first set of data (e.g., enrollment data) and the second set of data (e.g., feature data), wherein portions of the representation correspond to different confidence values. To these ends, in various implementations, the instruction includes instructions and/or logic therefor, and heuristics and metadata therefor.

Although the instruction set(s) 540 are shown as residing on a single device, it should be understood that in other implementations, any combination of the elements may be located in separate computing devices. Moreover, FIG. 5 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

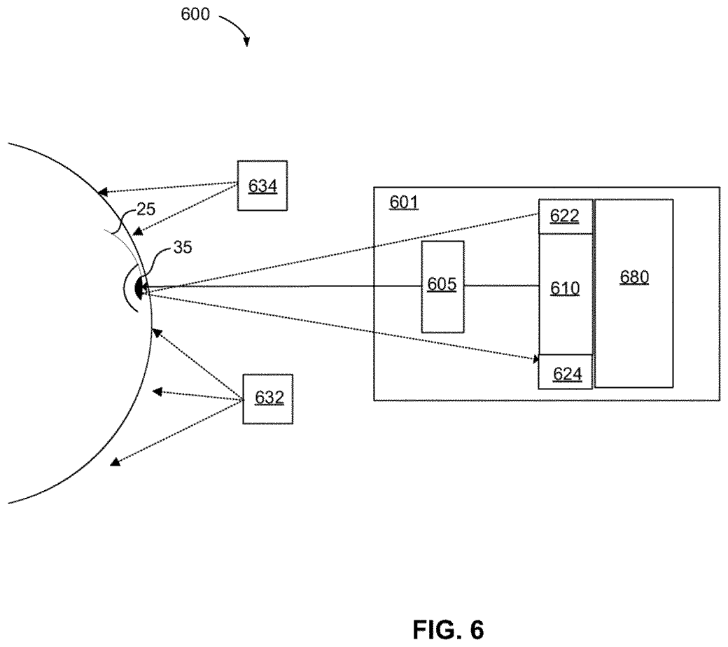

FIG. 6 illustrates a block diagram of an exemplary head-mounted device 600 in accordance with some implementations. The head-mounted device 600 includes a housing 601 (or enclosure) that houses various components of the head-mounted device 600. The housing 601 includes (or is coupled to) an eye pad (not shown) disposed at a proximal (to the user 25) end of the housing 601. In various implementations, the eye pad is a plastic or rubber piece that comfortably and snugly keeps the head-mounted device 600 in the proper position on the face of the user 25 (e.g., surrounding the eye of the user 25).

The housing 601 houses a display 610 that displays an image, emitting light towards or onto the eye of a user 25. In various implementations, the display 610 emits the light through an eyepiece having one or more lenses 605 that refracts the light emitted by the display 610, making the display appear to the user 25 to be at a virtual distance farther than the actual distance from the eye to the display 610. For the user 25 to be able to focus on the display 610, in various implementations, the virtual distance is at least greater than a minimum focal distance of the eye (e.g., 6 cm). Further, in order to provide a better user experience, in various implementations, the virtual distance is greater than 1 meter.

The housing 601 also houses a tracking system including one or more light sources 622, camera 624, camera 632, camera 634, and a controller 680. The one or more light sources 622 emit light onto the eye of the user 25 that reflects as a light pattern (e.g., a circle of glints) that can be detected by the camera 624. Based on the light pattern, the controller 880 can determine an eye tracking characteristic of the user 25. For example, the controller 680 can determine a gaze direction and/or a blinking state (eyes open or eyes closed) of the user 25. As another example, the controller 680 can determine a pupil center, a pupil size, or a point of regard. Thus, in various implementations, the light is emitted by the one or more light sources 622, reflects off the eye of the user 25, and is detected by the camera 624. In various implementations, the light from the eye of the user 25 is reflected off a hot mirror or passed through an eyepiece before reaching the camera 624.

The display 610 emits light in a first wavelength range and the one or more light sources 622 emit light in a second wavelength range. Similarly, the camera 624 detects light in the second wavelength range. In various implementations, the first wavelength range is a visible wavelength range (e.g., a wavelength range within the visible spectrum of approximately 400-700 nm) and the second wavelength range is a near-infrared wavelength range (e.g., a wavelength range within the near-infrared spectrum of approximately 700-1400 nm).

In various implementations, eye tracking (or, in particular, a determined gaze direction) is used to enable user interaction (e.g., the user 25 selects an option on the display 610 by looking at it), provide foveated rendering (e.g., present a higher resolution in an area of the display 610 the user 25 is looking at and a lower resolution elsewhere on the display 610), or correct distortions (e.g., for images to be provided on the display 610).

In various implementations, the one or more light sources 622 emit light towards the eye of the user 25 which reflects in the form of a plurality of glints.

In various implementations, the camera 624 is a frame/shutter-based camera that, at a particular point in time or multiple points in time at a frame rate, generates an image of the eye of the user 25. Each image includes a matrix of pixel values corresponding to pixels of the image which correspond to locations of a matrix of light sensors of the camera. In implementations, each image is used to measure or track pupil dilation by measuring a change of the pixel intensities associated with one or both of a user's pupils.

In various implementations, the camera 624 is an event camera including a plurality of light sensors (e.g., a matrix of light sensors) at a plurality of respective locations that, in response to a particular light sensor detecting a change in intensity of light, generates an event message indicating a particular location of the particular light sensor.

In various implementations, the camera 632 and camera 634 are frame/shutter-based cameras that, at a particular point in time or multiple points in time at a frame rate, can generate an image of the face of the user 25. For example, camera 632 captures images of the user's face below the eyes, and camera 634 captures images of the user's face above the eyes. The images captured by camera 632 and camera 634 may include light intensity images (e.g., RGB) and/or depth image data (e.g., Time-of-Flight, infrared, etc.).

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of physiological data to improve a user's experience of an electronic device with respect to interacting with electronic content. The present disclosure contemplates that in some instances, this gathered data may include personal information data that uniquely identifies a specific person or can be used to identify interests, traits, or tendencies of a specific person. Such personal information data can include physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve interaction and control capabilities of an electronic device. Accordingly, use of such personal information data enables calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access his or her stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various objects, these objects should not be limited by these terms. These terms are only used to distinguish one object from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “or” as used herein refers to and encompasses any and all possible combinations of one or more of the associated listed items. It will be further understood that the terms “comprises” or “comprising,” when used in this specification, specify the presence of stated features, integers, steps, operations, objects, or components, but do not preclude the presence or addition of one or more other features, integers, steps, operations, objects, components, or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

1. A method comprising:
at a processor:
obtaining a first set of data corresponding to features of a face of a user;
while a user is using an electronic device, obtaining a second set of data corresponding to one or more partial views of the face from one or more image sensors;
generating a representation of the face of the user based on the first set of data and the second set of data, wherein portions of the representation correspond to different confidence values; and
displaying the portions of the representation based on the corresponding confidence values.

2. The method of claim 1, wherein the first set of data comprises unobstructed image data of the face of the user.

3. The method of claim 1, wherein the second set of data comprises partial images of the face of the user.

4. The method of claim 1, wherein the electronic device comprises a first sensor and a second sensor, where the second set of data is obtained from at least one partial image of the face of the user from the first sensor from a first viewpoint and from at least one partial image of the face of the user from the second sensor from a second viewpoint that is different than the first viewpoint.

5. The method of claim 1, wherein the confidence values correspond to texture confidence value, wherein displaying the portions of the representation based on the corresponding confidence values comprises determining that the texture confidence value exceeds a threshold.

6. The method of claim 5, wherein generating the representation of the face of the user comprises:
tracking the features of the face of the user;
generating a model based on the tracked features; and
updating the model by projecting live image data onto the model.

7. The method of claim 6, wherein generating the representation of the face of the user further comprises enhancing the model based on the first set of data.

8. The method of claim 1, wherein the representation is a three-dimensional (3D) avatar.

9. The method of claim 1, wherein the portions of the representation are displayed based on assessing confidence that the respective portion accurately corresponds to a live appearance of the face of the user.

10. The method of claim 1, wherein the portions of the representation are displayed differently based on a confidence level of the corresponding confidence values.

11. The method of claim 1, wherein the second set of data comprises depth data and light intensity image data obtained during a scanning process.

12. The method of claim 1, wherein the electronic device is a head-mounted device (HMD).

13. The method of claim 1, wherein displaying the portions of the representation based on the corresponding confidence values comprises displaying the portions of the representations differently based on a confidence level of corresponding confidence values.

14. The method of claim 1, wherein displaying the portions of the representation based on the corresponding confidence values comprises, for a higher level of confidence, displaying a first portion of the representation and, for a lower level of confidence blurring or distorting the first portion of the representation.

15. The method of claim 1, wherein displaying the portions of the representation based on the corresponding confidence values comprises determining a level of distortion or blurring out of a first portion of the representation based on a confidence level for that first portion, wherein higher confidence corresponds to reduced blur or distortion.

16. The method of claim 15, wherein if a threshold level of confidence is reached, the first portion of the representation is displayed without any blur or distortion.

17. A device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations comprising:
obtaining a first set of data corresponding to features of a face of a user;
while a user is using an electronic device, obtaining a second set of data corresponding to one or more partial views of the face from one or more image sensors;
generating a representation of the face of the user based on the first set of data and the second set of data, wherein portions of the representation correspond to different confidence values; and
displaying the portions of the representation based on the corresponding confidence values.

18. The device of claim 17, wherein the first set of data comprises unobstructed image data of the face of the user.

19. The device of claim 17, wherein the second set of data comprises partial images of the face of the user.

20-25. (canceled)

26. A non-transitory computer-readable storage medium, storing program instructions executable on a device to perform operations comprising:
obtaining a first set of data corresponding to features of a face of a user;
while a user is using an electronic device, obtaining a second set of data corresponding to one or more partial views of the face from one or more image sensors;
generating a representation of the face of the user based on the first set of data and the second set of data, wherein portions of the representation correspond to different confidence values; and
displaying the portions of the representation based on the corresponding confidence values.
